(19) United States
(12) Patent Application Publication
(10) Pub. No.: US 2024/0411614 A1
(43) Pub. Date: Dec. 12, 2024

(54) ISCSI SERVICE LOAD BALANCING METHOD AND APPARATUS, AND DEVICE AND MEDIUM

(71) Applicant: SUZHOU METABRAIN INTELLIGENT TECHNOLOGY CO., LTD., Suzhou, Jiangsu (CN)

(72) Inventors: Menglong LI, Suzhou, Jiangsu (CN); Xiangdong MU, Suzhou, Jiangsu (CN)

(21) Appl. No.: 18/709,801

(22) PCT Filed: Mar. 1, 2023
(86) PCT No.: PCT/CN2023/078917

§ 371 Date: May 13, 2024

(30) Foreign Application Priority Data
Mar. 2, 2022 (CN) 202210194947.5

(51) Int. Cl. G06F 9/50

(52) U.S. Cl. CPC G06F 9/5083; G06F 9/5016; G06F 9/5038

(57) ABSTRACT

An internet small computer system interface (iSCSI) service load balancing method is provided by the present application, which includes: uniformly distributing volumes onto different target objects; acquiring information of a plurality of racks where available storage nodes are located and information of available volumes in the available storage nodes, and according to the acquired information of the racks where the available storage nodes are located and the acquired information of the available volumes in the available storage nodes, determining to-be-accessed storage nodes corresponding to current storage tasks, so that the current storage tasks are uniformly allocated to the available volumes of different available storage nodes in the racks; returning the determined to-be-accessed storage nodes to a client for use by the user. An iSCSI service load balancing apparatus, a device and a medium are further provided by the present application.

### CROSS-REFERENCE TO RELATED APPLICATION

This application claims the priority of the Chinese Patent application filed on March 2^{nd}, 2022 before the China National Intellectual Property Administration with the application number of 202210194947.5, and the title of “ISCSI SERVICE LOAD BALANCING METHOD AND APPARATUS, AND DEVICE AND MEDIUM”, which is incorporated herein in its entirety by reference.

### FIELD

The present application relates to the field of an internet small computer system interface (iSCSI) service and, more particularly, to an iSCSI service load balancing method and apparatus, a device and a medium.

### BACKGROUND

In an iSCSI storage service, volumes are generally distributed onto target objects in different storage nodes. However, in the storage service, storage nodes or volumes are generally randomly selected, so that a service load is not balanced.

In order to balance the service load, in the prior art, a user may manually select different storage nodes if the user is very familiar with a storage environment. However, the user does not know which storage nodes are selected. Volumes provided by an iSCSI service of a storage cluster may be uniformly distributed on different racks, the storage nodes, and target objects. In addition, the manual selection method is low in efficiency, high in time cost, and low in reliability.

### SUMMARY

In order to solve the problems in the prior art, the present application innovatively provides an iSCSI service load balancing method and apparatus, a device and a medium, the problems of low efficiency, high cost, and low reliability caused by manual selection of storage nodes are effectively solved, the reliability of the iSCSI service load balancing is effectively improved, the cost of selecting the storage nodes is reduced, and the selection efficiency is improved.

An iSCSI service load balancing method is provided by the present application, which includes:
uniformly distributing volumes onto different target objects;
acquiring information of a plurality of racks where available storage nodes are located and information of available volumes in the available storage nodes, and according to the acquired information of the racks where the available storage nodes are located and the acquired information of the available volumes in the available storage nodes, determining to-be-accessed storage nodes corresponding to current storage tasks, so that the current storage tasks are uniformly allocated to the available volumes of different available storage nodes in the racks; and
returning the determined to-be-accessed storage nodes to a client for use by the user.

In some embodiments, uniformly distributing the volumes onto the different target objects includes:
creating the plurality of target objects and a plurality of threads on an iSCSI service corresponding to each available storage node, wherein each thread independently corresponds to the available volumes on the target objects; and
performing a remainder calculation operation on target-object identifiers through volume identifiers to make that the volumes are uniformly distributed onto the different target objects.

In some embodiments, a quantity of the target objects is correspondingly the same as a quantity of the threads, and the threads are bound to the target objects in a one-to-one corresponding manner.

In some embodiments, acquiring the information of the racks where the available storage nodes are located and the information of the available volumes in the available storage nodes, and according to the acquired information of the racks where the available storage nodes are located and the acquired information of the available volumes in the available storage nodes, determining the to-be-accessed storage nodes corresponding to the current storage tasks includes:
acquiring the information of the racks where the available storage nodes are located and the information of the available volumes in the available storage nodes;
arranging the available storage nodes according to the information of the available volumes in the available storage nodes; and
according to a quantity of the available storage nodes required by the current storage tasks of a user and the information of the racks corresponding to the available storage nodes, determining a number of rounds required for accessing an available volume list, polling the racks corresponding to all the available storage nodes in sequence, and selecting, from one currently polled rack, one available volume in one available storage node that is arranged in a front in the currently polled rack at each round until the current storage tasks of the user are completed

In some embodiments, arranging the available storage nodes according to the information of the available volumes in the available storage nodes is:
performing an ascending arrangement on the available storage nodes according to quantity information of the available volumes in the available storage nodes.

In some embodiments, according to the quantity of the available storage nodes required by the current storage tasks of the user and the information of the racks corresponding to the available storage nodes, determining the number of rounds required for accessing the available volume list is:
performing a division operation on the quantity of the available storage nodes required by the current storage tasks of the user and quantity information of the racks corresponding to the available storage nodes; in response to that there is a remainder, indicating that the number of rounds required for accessing the available volume list is a quotient of the quantity of the available storage nodes required by the current storage tasks of the user and the quantity information of the racks corresponding to the available storage nodes plus 1; and in response to that there is no remainder, indicating that the number of rounds required for accessing the available volume list is a quotient of the quantity of the available storage nodes required by the current storage tasks of the user and the quantity information of the racks corresponding to the available storage nodes.

In some embodiments, returning the determined to-be-accessed storage nodes to the client for use by the user is: arranging the determined to-be-accessed storage nodes according to the information of the available volumes in the available storage nodes, generating storage node linked lists, and returning the generated storage node linked lists to the client for use by the user in a unified way.

An iSCSI service load balancing apparatus is further provided by the present application, which includes:
a distribution module configured to uniformly distribute volumes onto different target objects;
a determining module configured to acquire information of a plurality of racks where available storage nodes are located and information of available volumes in the available storage nodes, and according to the acquired information of the racks where the available storage nodes are located and the acquired information of the available volumes in the available storage nodes, determine to-be-accessed storage nodes corresponding to current storage tasks, so that the current storage tasks are uniformly allocated to the available volumes of different available storage nodes in the racks; and
a returning module configured to return the determined to-be-accessed storage nodes to a client for use by the user.

An electronic device is further provided by the present application, which includes: a memory configured to store a computer program; and a processor configured to implement, when executing the computer program, the steps of the iSCSI service load balancing method according to the present application.

A non-transitory computer-readable storage medium is further provided by the present application, wherein the non-transitory computer-readable storage medium stores a computer program, and the non-transitory computer program, when executed by a processor, implement the steps of the iSCSI service load balancing method according to the present application.

The technical solutions used by the present application include the following technical effects:

1. According to the present application, the volumes are uniformly distributed onto different target objects, and the to-be-accessed storage nodes corresponding to the current storage tasks are determined according to the acquired information of the racks where the available storage nodes are located and the acquired information of the available volumes in the available storage nodes, so that the current storage tasks are uniformly allocated to the available volumes of different available storage nodes in the plurality of racks. The problems of low efficiency, high cost, and poor reliability caused by manual selection of storage nodes are effectively solved, the reliability of iSCSI service load balancing is effectively improved, the cost of selection of the storage nodes is reduced, and the selection efficiency is improved.

2. In the technical solutions of the present application, the quantity of the target objects created in each available storage node is correspondingly the same as the quantity of the threads, and the threads are bound to the target objects in the one-to-one corresponding manner. This not only makes that the volumes may be uniformly distributed at different storage nodes and target objects, but also fully uses the storage IO performance of the concurrently accessed volumes.

3. In the technical solutions of the present application, the available storage nodes are arranged according to the information of the available volumes in the available storage nodes; the number of rounds required for accessing the available volume list is determined according to the quantity of available storage nodes required by the current storage tasks of a user and the information of the racks corresponding to the available storage nodes; the racks corresponding to all the available storage nodes are polled in sequence; and one available volume in one available storage node that is arranged in the front in the currently polled rack at each round is selected from one currently polled rack until the current storage tasks of the user are completed. Therefore, when the user accesses a storage cluster in a large scale, storage IO may be relatively uniformly distributed to different racks, different storage nodes, and different target objects.

4. In the technical solutions of the present application, the determined to-be-accessed storage nodes are arranged according to the information of the available volumes in the available storage nodes, the storage node linked lists are generated, and the generated storage node linked lists are returned to the client for use by the user in a unified way. It is convenient for the user to receive all the available storage nodes corresponding to the current storage tasks at one time, so that the returning efficiency and the user experience are improved.

It should be understood that the foregoing general descriptions and the following detailed descriptions are merely for illustration and explanation purposes and are not intended to limit the present application.

### BRIEF DESCRIPTION OF THE DRAWINGS

In order to more clearly explain the technical solution in the embodiments of the present application or the prior art, the drawings that needs to be used in the description of the embodiments or the prior art will be briefly introduced below. Obviously, a person skilled in the art may also obtain other drawing without paying creative labor.

FIG. 1 is a flowchart of an iSCSI service load balancing method according to an embodiment of the present application;

FIG. 2 is a flowchart of step S1 in an iSCSI service load balancing method according to an embodiment of the present application;

FIG. 3 is a schematic structural diagram showing the racks (denoted by rack in FIG. 3), the storage nodes, the target objects (denoted by target in FIG. 3) and volumes (denoted by lun in FIG. 3) in an iSCSI service load balancing method according to an embodiment of the present application;

FIG. 4 is a flowchart of step S2 in an iSCSI service load balancing method according to an embodiment of the present application;

FIG. 5 is a schematic structural diagram of an iSCSI service load balancing apparatus according to an embodiment of the present application;

FIG. 6 is a schematic structural diagram of an electronic device according to an embodiment of present application; and

FIG. 7 is a structural diagram of a non-transitory computer-readable storage medium according to an embodiment of the present application.

### DETAILED DESCRIPTION

In order to clearly explain the technical characteristics of this solution, the following is a detailed explanation of the present application through implementations and in combination with accompanying drawings of the present application. The following disclosure provides many different embodiments or examples to implement different structures of the present application.

In order to simplify the disclosure of the present application, components and settings of examples are described below. In addition, the present application may repeatedly refer to numbers and/or letters in different examples. Such repetition is for purposes of simplicity and clarity and the repetition itself does not indicate a relationship between the various embodiments and/or settings discussed. It should be noted that the components illustrated in the accompanying drawings may not necessarily be drawn to scale. The present application omits descriptions of well-known components, processing technologies, and processes to avoid unnecessary limitations on the present application.

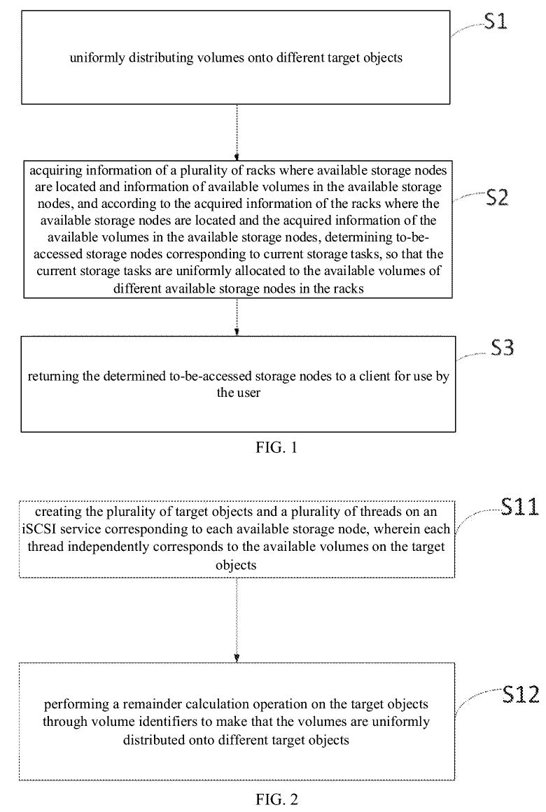

As shown in FIG. 1, the present application provides an iSCSI service load balancing method, including:
S1: uniformly distributing volumes onto different target objects;
S2: acquiring information of a plurality of racks where available storage nodes are located and information of available volumes in the available storage nodes, and according to the acquired information of the racks where the available storage nodes are located and the acquired information of the available volumes in the available storage nodes, determining to-be-accessed storage nodes corresponding to current storage tasks, so that the current storage tasks are uniformly allocated to the available volumes of different available storage nodes in the racks;
S3: returning the determined to-be-accessed storage nodes to a client for use by the user.

As shown in FIG. 2 to FIG. 3, step S1 includes:
S11: creating the plurality of target objects and a plurality of threads on an iSCSI service corresponding to each available storage node, wherein each thread independently corresponds to the available volumes on the target objects.
S12: performing a remainder calculation operation on target-object identifiers through volume identifiers to make that the volumes are uniformly distributed onto the different target objects.

In step S11, a quantity of the target objects is correspondingly the same as a quantity of the threads, and the threads are bound to the target objects in a one-to-one corresponding manner.

Firstly, eight target objects are created on a TGT service (an iSCSI service, namely, tgtd in FIG. 3). There are eight threads in the TGT service by default. Each thread may independently access the volumes on the corresponding target object (thread 1 may only access the volumes in target 1, and so on), and concurrently access the storage IO performance of the volumes.

In step S12, the volumes are uniformly distributed onto different target objects. Each target object has a tid for identifying the target object, and each volume also has a lun_id to identify different volumes. By use of lun_id % tid, that is, the remainder calculation operation is performed on the target-object identifiers through the volume identifiers, so that the volumes may be distributed onto different target objects, wherein both tid and lun_id may be reused. The volume identifiers of the plurality of volumes are numbered from 1 to n, and the target-object identifiers of the plurality target objects are numbered from 1 to n. For each volumes, the remainder calculation operation is performed on the volume identifier of the volume and a maximum value of the target-object identifiers, and an obtained remainder is the target-object identifier of the target object to which the volume belongs, so that the volumes are uniformly distributed onto different target objects.

For example, when there are eight volumes and four target objects, the volume identifiers of the eight volumes are 1, 2, 3, 4, 5, 6, 7, 8, and the target-object identifiers of the four target objects are 1, 2, 3, and 4. The maximum target-object identifier is 4. For the volume with a volume identifier 1, the remainder calculation operation is performed on the volume identifier and the target-object identifiers, that is, 1%4, so that a remainder of 1 is obtained. At this moment, the volume with the volume identifier 1 is distributed onto the target object with a target-object identifier of 1. For the volume with a volume identifier 2, the remainder calculation operation is performed on the volume identifier and the target-object identifiers, that is, 2%4, so that a remainder of 2 is obtained. At this moment, the volume with the volume identifier 2 is distributed onto the target object with a target-object identifier of 2. In the same way, the volume with a volume identifier of 3 is distributed onto the target object with a target-object identifier of 3; the volume with a volume identifier of 4 is distributed onto the target object with a target-object identifier of 4; the volume with a volume identifier of 5 is distributed onto the target object with the target-object identifier of 1; the volume with a volume identifier of 6 is distributed onto the target object with the target-object identifier of 2; the volume with a volume identifier of 7 is distributed onto the target object with target-object identifier of 3; and the volume with a volume identifier of 8 is distributed onto the target object with the target-object identifier of 4, thus that the volumes uniformly are distributed onto different target objects is realized.

In some embodiments, step S12 may be further replaced by the following step:
performing a remainder calculation operation on a quantity of the target objects through volume identifiers to make that the volumes are uniformly distributed onto different target objects.

The volume identifiers of the plurality of volumes are numbered from 0 to n, and the target-object identifiers of the plurality target objects are numbered from 0 to n. For each volumes, the remainder calculation operation is performed on the volume identifier of the volume and the quantity of the target objects, and an obtained remainder is the target-object identifier of the target object to which the volume belongs.

For example, when there are eight volumes and four target objects, the volume identifiers of the eight volumes are 0, 1, 2, 3, 4, 5, 6, 7, and the target-object identifiers of the four target objects are 0, 1, 2, and 3. For the volume with a volume identifier 0, the remainder calculation operation is performed on the volume identifier and the target-object identifiers, that is, 0%4, so that a remainder of 0 is obtained. At this moment, the volume with a volume identifier of 0 is distributed onto the target object with target-object identifier of 0. For the volume with a volume identifier of 1, the remainder calculation operation is performed on the volume identifier of and the target-object identifiers, that is, 1%4, so that a remainder of 1 is obtained. At this moment, the volume with the volume identifier of 1 is distributed onto the target object with a target-object identifier of 1. In the same way, the volume with a volume identifier of 2 is distributed onto the target object with a target-object identifier of 2; the volume with a volume identifier of 3 is distributed onto the target object with a target-object identifier of 3; the volume with a volume identifier of 4 is distributed onto the target object with a target-object identifier of 0; the volume with a volume identifier of 5 is distributed onto the target object with the target-object identifier of 1; the volume with a volume identifier of 6 is distributed onto the target object with the target-object identifier of 2; and the volume with a volume identifier of 7 is distributed onto the target object with the target-object identifier of 3, thus that the volumes are uniformly distributed onto different target objects is realized.

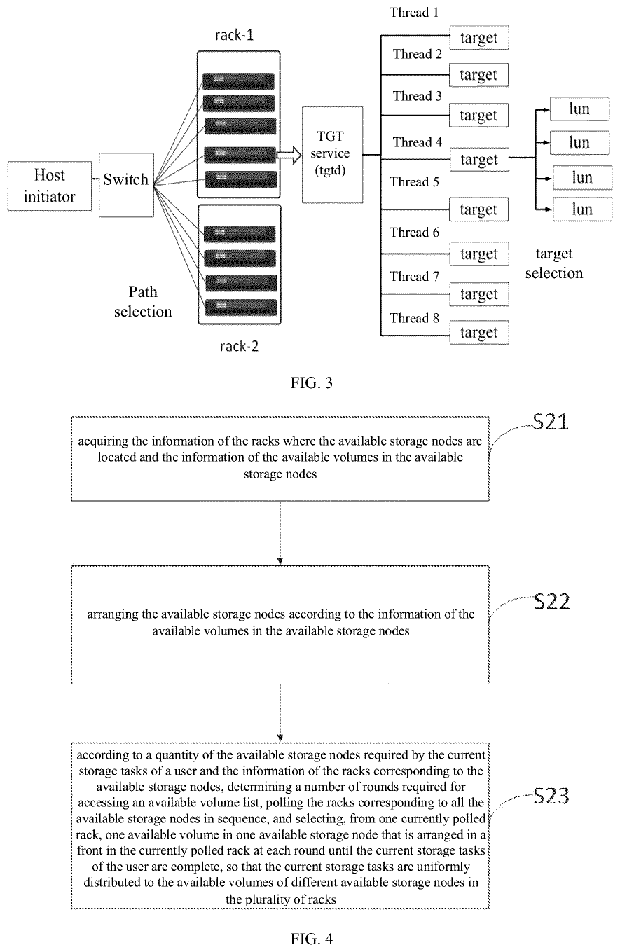

As shown in FIG. 4, step S2 includes:
S21: acquiring the information of the racks where the available storage nodes are located and the information of the available volumes in the available storage nodes;
S22: arranging the available storage nodes according to the information of the available volumes in the available storage nodes;
S23: according to a quantity of the available storage nodes required by the current storage tasks of a user and the information of the racks corresponding to the available storage nodes, determining a number of rounds required for accessing an available volume list, polling the racks corresponding to all the available storage nodes in sequence, and selecting, from one currently polled rack, one available volume in one available storage node that is arranged in a front in the currently polled rack at each round until the current storage tasks of the user are completed, so that the current storage tasks are uniformly distributed to the available volumes of different available storage nodes in the plurality of racks.

In step S21, the information rackid of the racks where the available storage nodes (namely, storage nodes in a working state) and the quantity information of the available volumes in the available storage nodes are acquired from a MON service process (a monitoring service process).

In step S22, arranging the available storage nodes according to the information of the available volumes in the available storage nodes is: performing an ascending arrangement on the available storage nodes according to the quantity information of the available volumes in the available storage nodes. If the quantity of the available volumes in an available storage node is smaller, the arrangement order of the available storage node is smaller. For example, in a storage node 1, there are 12 available volumes; in a storage node 2, there are 11 available volumes; in a storage node 3, there are 14 available volumes; and in a storage node 4, there are 13 available volumes. The storage node 1, the storage node 2, the storage node 3, and the storage node 4 are all available storage nodes. According to the quantity information of the available volumes in the available storage nodes, the ascending arrangement of the available storage nodes is as follows: the storage node 2, the storage node 1, the storage node 4, and the storage node 3. In step S23, according to the arrangement orders of the plurality of available storage nodes in the same rack, it is determined that a plurality of available storage nodes in the currently polled rack in the current storage task are preferentially selected at the current round.

In step S23, according to the quantity of available storage nodes required by the current storage tasks of the user and the information of the racks corresponding to the available storage nodes, determining the number of rounds required for accessing the available volume list is:
performing a division operation on the quantity of the available storage nodes required by the current storage tasks of the user and quantity information of the racks corresponding to the available storage nodes; in response to that there is a remainder, indicating that the number of rounds required for accessing the available volume list is a quotient of the quantity of the available storage nodes required by the current storage tasks of the user and the quantity information of the racks corresponding to the available storage nodes plus 1; and in response to that there is no remainder, indicating that the number of rounds required for accessing the available volume list is a quotient of the quantity of the available storage nodes required by the current storage tasks of the user and the quantity information of the racks corresponding to the available storage nodes. For example, if 12 available storage nodes are required by the current storage tasks of the user, and the quantity information of the racks corresponding to the available storage nodes is two, the number of rounds required for accessing the available volume list is 12/2=6, that is, the available volume list is polled for six times to complete the current storage tasks of the user. If 12 available storage nodes are required by the current storage tasks of the user, and the quantity information of the racks corresponding to the available storage nodes is five, the number of rounds required for accessing the available volume list is 12/5=2 . . . 2, that is, the available volume list is polled for 2+1=3 times to complete the current storage tasks of the user.

After the number of rounds required by the current storage tasks for accessing the available volume list is determined, the racks corresponding to all the available storage nodes are polled in sequence, and one available volume in one available storage node (available storage nodes that include a small number of available volumes are preferentially accessed) that is arranged at the front in the currently polled rack is selected from one currently polled rack at each round until the current storage tasks of the user are completed, so that the current storage tasks are uniformly allocated to the available volumes of different available storage nodes in the plurality of racks.

Further, in order to uniformly allocate the current storage tasks to the available volumes of different target objects in different available storage nodes in the plurality of racks, a selection order of the available volumes in the same available storage node may also be in accordance with an order of the quantities of the available volumes contained in the target objects, or may be in accordance with other orders, which is not limited by the present application. Selection is performed according to the order of the target objects, which means that the ascending arrangement is performed on the available target objects according to the quantity information of the available volumes in the available target objects in each available storage node. If the quantity of the available volumes in an available target object is smaller, the arrangement order of the available target is smaller. For example, in a target 1, there are two available volumes; in a target 2, there is one available volumes; in a target 3, there are four available volumes; and in a target 4, there are three available volumes. According to the quantity information of the available volumes in the available storage nodes, the ascending arrangement of the target objects is as follows: the target 2, the target 1, the target 4, and the target 3. One available volume in one available target object (available target objects that include a small number of available volumes are preferentially accessed) that is arranged in the front in the currently polled rack is selected from one currently polled rack at each round until the current storage tasks of the user are completed, so that the current storage tasks are uniformly allocated to the available volumes of different available target objects in different available storage nodes in the plurality of racks.

In some embodiments, a polling linked list may be established for each rack. The polling linked list generates a hash table by taking the acquired rackid as a subscript, and records a number of times of polling of the rack. Further, the numbers of times of polling of all the racks are the same, and are equal to the number of rounds required by the current storage tasks for accessing the available volume list. In special circumstances, the number of times of polling of at least one rack is the same as the number of rounds required by the current storage tasks for accessing the available volume list, and the number of times of polling of the rack, which is the same as the number of rounds required by the current storage tasks for accessing the available volume list, is a minimum value of the numbers of times of polling of all the racks corresponding to the available storage nodes, to ensure that the current storage tasks are uniformly allocated to the available volumes of different available storage nodes in the plurality of racks.

In step S3, returning the determined to-be-accessed storage nodes to the client for use by the user is: arranging the determined to-be-accessed storage nodes according to the information of the available volumes in the available storage nodes, generating storage node linked lists, and returning the generated storage node linked lists to the client initiator for use by the user in a unified way.

The generated storage node linked list may be a unidirectional linked list, which means that unidirectional access is conducted between the determined available to-be-accessed storage nodes, or a bidirectional linked list, which means that bidirectional access is conducted between the determined available to-be-accessed storage nodes.

According to the present application, the volumes are uniformly distributed onto different target objects, and the to-be-accessed storage nodes corresponding to the current storage tasks are determined according to the acquired information of the racks where the available storage nodes are located and the acquired information of the available volumes in the available storage nodes, so that the current storage tasks are uniformly allocated to the available volumes of different available storage nodes in the plurality of racks. The problems of low efficiency, high cost, and poor reliability caused by manual selection of storage nodes are effectively solved, the reliability of iSCSI service load balancing is effectively improved, the cost of selection of the storage nodes is reduced, and the selection efficiency is improve.

In the technical solutions of the present application, the quantity of the target objects created in each available storage node is correspondingly the same as the quantity of the threads, and the threads are bound to the target objects in the one-to-one corresponding manner. This not only makes that the volumes may be uniformly distributed at different storage nodes and target objects, but also fully uses the storage IO performance of the concurrently accessed volumes.

In the technical solutions of the present application, the available storage nodes are arranged according to the information of available volumes in the available storage nodes; the number of rounds required for accessing the available volume list is determined according to the quantity of available storage nodes required by the current storage tasks of a user and the information of the racks corresponding to the available storage nodes; the racks corresponding to all the available storage nodes are polled in sequence; and one available volume in one available storage node that is arranged in the front in the currently polled rack at each round is selected from one currently polled rack until the current storage tasks of the user are completed.

Therefore, when the user accesses a storage cluster in a large scale, storage IO may be relatively distributed to different racks, different storage nodes, and different target objects.

In the technical solutions of the present application, the determined to-be-accessed storage nodes are arranged according to the information of the available volumes in the available storage nodes, the storage node linked lists are generated, and the generated storage node linked lists are returned to the client for use by the user in a unified way. It is convenient for the user to receive all the available storage nodes corresponding to the current storage tasks at one time, so that the returning efficiency and the user experience are improved.

As shown in FIG. 5, an iSCSI service load balancing apparatus is further provided by the present application, including:
a distribution module 101 configured to uniformly distribute volumes onto different target objects;
a determining module 102 configured to acquire information of a plurality of racks where available storage nodes are located and information of available volumes in the available storage nodes, and according to the acquired information of the racks where the available storage nodes are located and the acquired information of the available volumes in the available storage nodes, determine to-be-accessed storage nodes corresponding to current storage tasks, so that the current storage tasks are uniformly allocated to the available volumes of different available storage nodes in the racks; and
a returning module 103 configured to return the determined to-be-accessed storage nodes to a client for use by the user, so that the current storage tasks are uniformly allocated to the available volumes of different available storage nodes in the plurality of racks.

According to the present application, the volumes are uniformly distributed onto different target objects, and the to-be-accessed storage nodes corresponding to the current storage tasks are determined according to the acquired information of the racks where the available storage nodes are located and the acquired information of the available volumes in the available storage nodes, so that the current storage tasks are uniformly allocated to the available volumes of different available storage nodes in the plurality of racks. The problems of low efficiency, high cost, and poor reliability caused by manual selection of storage nodes are effectively solved, the reliability of iSCSI service load balancing is effectively improved, the cost of selection of the storage nodes is reduced, and the selection efficiency is improved.

In the technical solutions of the present application, the quantity of the target objects created in each available storage node is correspondingly the same as the quantity of the threads, and the threads are bound to the target objects in the one-to-one corresponding manner. This not only makes that the volumes may be uniformly distributed at different storage nodes and target objects, but also fully uses the storage IO performance of the concurrently accessed volumes.

In the technical solutions of the present application, the available storage nodes are arranged according to the information of the available volumes in the available storage nodes; the number of rounds required for accessing the available volume list is determined according to the quantity of available storage nodes required by the current storage tasks of a user and the information of the racks corresponding to the available storage nodes; the racks corresponding to all the available storage nodes are polled in sequence; and one available volume in one available storage node that is arranged in the front in the currently polled rack at each round is selected from one currently polled rack until the current storage tasks of the user are completed.

Therefore, when the user accesses a storage cluster in a large scale, storage IO may be relatively distributed to different racks, different storage nodes, and different target objects.

In the technical solutions of the present application, the determined to-be-accessed storage nodes are arranged according to the information of the available volumes in the available storage nodes, the storage node linked lists are generated, and the generated storage node linked lists are returned to the client for use by the user in a unified way. It is convenient for the user to receive all the available storage nodes corresponding to the current storage tasks at one time, so that the returning efficiency and the user experience are improved.

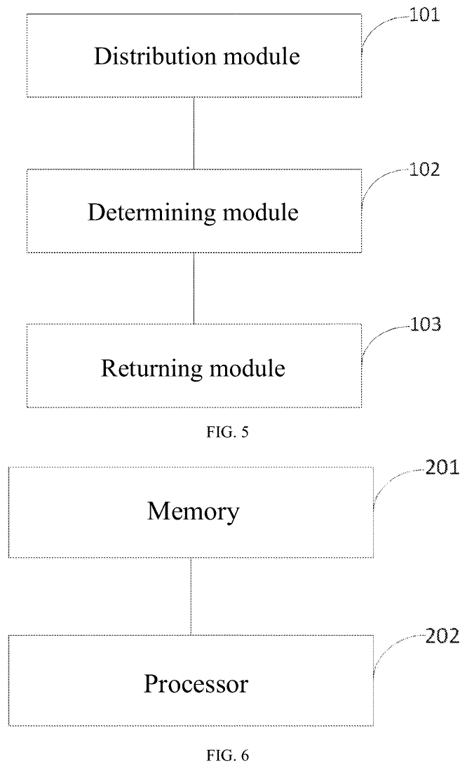

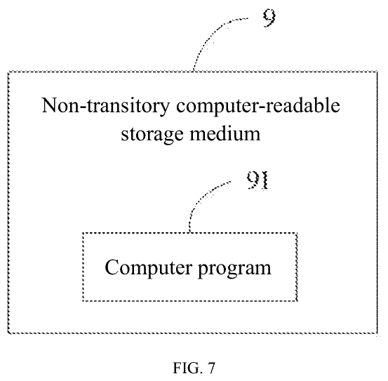

As shown in FIG. 6, an electronic device is further provided by the present application, including: a memory 201 configured to store a computer program; and a processor 202, configured to implement, when executing the computer program, the steps of the iSCSI service load balancing method described above.

The memory 201 in the embodiments of the present application is configured for storing various types of data to support operations performed on the electronic device. Examples of the data include any computer programs configured to be operated on the electronic device. It may be understood that the memory 201 may be a transitory memory or a non-transitory memory, or may include both a transitory memory and a non-transitory memory. The non-transitory memory may be a read only memory (ROM), a programmable read-only memory (PROM), an erasable programmable read-only memory (EPROM), an electrically erasable programmable read-only memory (EEPROM), a ferromagnetic random access memory (FRAM), a flash memory, a magnetic surface memory, an optical disc, or a compact disc read-only memory (CD-ROM); and the magnetic surface memory may be either a magnetic disk memory or magnetic tape memory. The transitory memory may be a random access memory (RAM) serving as an external cache. Through illustrative but not limited description, RAMs in many forms, for example, a static random access memory (SRAM), a synchronous static random access memory (SSRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synclink dynamic random access memory (SLDRAM), and a direct rambus random access memory (DRRAM). The memory 201 described in the embodiments of the present application aims to include these and any other suitable types of memories.

The above method disclosed in the embodiments of the present application may be applied to the processor 202, or implemented by the processor 202. The processor 202 may be an integrated circuit chip, which has a signal processing capability. In an implementation process, all the steps of the above method may be completed through an integrated logic circuit of hardware in the processor 202 or instructions in the form of software. The above processor 202 may be a general-purpose processor, a digital signal processor (DSP, which is a chip capable of achieving a digital signal processing technology), or another programmable logical device, a discrete gate or transistor logical device, a discrete hardware component, and the like. The processor 202 may implement or perform the methods, steps, and logic block diagrams that are disclosed in the embodiments of the present application. The general-purpose processor may be a microprocessor, any conventional processor, or the like. The steps of the methods disclosed in the embodiments of the present application may be directly performed and completed by a hardware decoding processor, or performed and completed by combining hardware and software modules in a decoding processor. The software modules may be located in a storage medium. The storage medium is located in the memory 201. The processor 202 reads programs in the memory 201 and completes the steps of the above method in combination with the hardware of the processor. When the processor 202 executes the program, the corresponding processes in each method of the embodiments of the present application are implemented. For simplicity, they will not be elaborated here.

According to the present application, the volumes are uniformly distributed onto different target objects, and the to-be-accessed storage nodes corresponding to the current storage tasks are determined according to the acquired information of the racks where the available storage nodes are located and the acquired information of the available volumes in the available storage nodes, so that the current storage tasks are uniformly allocated to the available volumes of different available storage nodes in the plurality of racks. The problems of low efficiency, high cost, and poor reliability caused by manual selection of storage nodes are effectively solved, the reliability of iSCSI service load balancing is effectively improved, the cost of selection of the storage nodes is reduced, and the selection efficiency is improved.

In the technical solutions of the present application, the quantity of the target objects created in each available storage node is correspondingly the same as the quantity of the threads, and the threads are bound to the target objects in the one-to-one corresponding manner. This not only makes that the volumes may be uniformly distributed at different storage nodes and target objects, but also fully uses the storage IO performance of the concurrently accessed volumes.

In the technical solutions of the present application, the available storage nodes are arranged according to the information of the available volumes in the available storage nodes; the number of rounds required for accessing the available volume list is determined according to the quantity of available storage nodes required by the current storage tasks of a user and the information of the racks corresponding to the available storage nodes; the racks corresponding to all the available storage nodes are polled in sequence; and one available volume in one available storage node that is arranged in the front in the currently polled rack at each round is selected from one currently polled rack until the current storage tasks of the user are completed.

Therefore, when the user accesses a storage cluster in a large scale, storage IO may be relatively distributed to different racks, different storage nodes, and different target objects.

In the technical solutions of the present application, the determined to-be-accessed storage nodes are arranged according to the information of the available volumes in the available storage nodes, the storage node linked lists are generated, and the generated storage node linked lists are returned to the client for use by the user in a unified way. It is convenient for the user to receive all the available storage nodes corresponding to the current storage tasks at one time, so that the returning efficiency and the user experience are improved.

A non-transitory computer-readable storage medium 9 is further provided by the present application. The non-transitory computer-readable storage medium 9 stores a computer program 91. The computer program 91, when executed by a processor, executes the steps of the iSCSI service load balancing method described above.

For example, the non-transitory computer-readable storage medium includes the memory 201 that stores the computer program 91. The above computer program 91 may be executed by the processor 202 to complete the steps of the foregoing method. The non-transitory computer-readable storage medium 9 may be an FRAM, a ROM, a PROM, an EPROM, an EEPROM, a flash memory, a magnetic surface memory, an optical disc, a CD-ROM, or the like.

A person skilled in the art may understand that all or some of the steps of the above method embodiment may be implemented through hardware related to programs and instructions. The aforementioned programs may be stored in a non-transitory computer-readable storage medium 9. When the program is executed, the steps included in the above method embodiment are executed. The aforementioned storage medium includes various media that may store program codes, such as a mobile storage device, a ROM, a RAM, a magnetic disc, or an optical disc. Or, in the present application, when the integrated unit is implemented in the form of a software functional module and sold or used as an independent product, the integrated unit may also be stored in a non-transitory computer-readable storage medium 9. Based on such an understanding, the technical solutions of the embodiments of the present application essentially, or the part contributing to the prior art may be embodied in the form of a software product. The computer software product is stored in a storage medium and includes several instructions for instructing an electronic device (which may be a personal computer, a server, a network device, or the like) to execute all or some of the methods described in the present application. The aforementioned storage media include: various media that may store program codes, such as a mobile storage device, a ROM, a RAM, a magnetic disc, or an optical disc.

According to the present application, the volumes are uniformly distributed onto different target objects, and the to-be-accessed storage nodes which correspond to the current storage tasks are determined according to the acquired information of the racks where the available storage nodes are located and the acquired information of the available volumes in the available storage nodes, so that the current storage tasks are uniformly allocated to the available volumes of different available storage nodes in the plurality of racks. The problems of low efficiency, high cost, and poor reliability caused by manual selection of storage nodes are effectively solved, the reliability of iSCSI service load balancing is effectively improved, the cost of selection of the storage nodes is reduced, and the selection efficiency is improved.

In the technical solutions of the present application, the quantity of the target objects created in each available storage node is correspondingly the same as the quantity of the threads, and the threads are bound to the target objects in the one-to-one corresponding manner. This not only makes that the volumes may be uniformly distributed at different storage nodes and target objects, but also fully uses the storage IO performance of the concurrently accessed volumes.

In the technical solutions of the present application, the available storage nodes are arranged according to the information of the available volumes in the available storage nodes; the number of rounds required for accessing the available volume list is determined according to the quantity of available storage nodes required by the current storage tasks of a user and the information of the racks corresponding to the available storage nodes; the racks corresponding to all the available storage nodes are polled in sequence; and one available volume in one available storage node that is arranged in the front in the currently polled rack at each round is selected from one currently polled rack until the current storage tasks of the user are completed. Therefore, when the user accesses a storage cluster in a large scale, storage IO may be relatively distributed to different racks, different storage nodes, and different target objects.

In the technical solutions of the present application, the determined to-be-accessed storage nodes are arranged according to the information of the available volumes in the available storage nodes, the storage node linked lists are generated, and the generated storage node linked lists are returned to the client for use by the user in a unified way. It is convenient for the user to receive all the available storage nodes corresponding to the current storage tasks at one time, so that the returning efficiency and the user experience are improved.

Although the implementations of the present application have been described in conjunction with the accompanying drawings, they do not impose limitations on the scope of protection of the present application. Those skilled in the art should understand that various modifications or variations that may be made without paying creative labor on the basis of the technical solutions of the present application shall still fall within the scope of protection of the present application.

1. An internet small computer system interface (iSCSI) service load balancing method, comprising:
uniformly distributing volumes onto different target objects;
acquiring information of a plurality of racks where available storage nodes are located and information of available volumes in the available storage nodes, and according to the acquired information of the racks where the available storage nodes are located and the acquired information of the available volumes in the available storage nodes, determining to-be-accessed storage nodes corresponding to current storage tasks, so that the current storage tasks are uniformly allocated to the available volumes of different available storage nodes in the racks, wherein a plurality of target objects are created on an iSCSI service corresponding to each available storage node, and each target object corresponds to a plurality of volumes; acquiring the information of the racks where the available storage nodes are located and the information of the available volumes in the available storage nodes, and according to the acquired information of the racks where the available storage nodes are located and the acquired information of the available volumes in the available storage nodes, determining the to-be-accessed storage nodes corresponding to the current storage tasks comprises:
acquiring the information of the racks where the available storage nodes are located and the information of the available volumes in the available storage nodes;
arranging the available storage nodes according to the information of the available volumes in the available storage nodes; and
according to a quantity of the available storage nodes required by the current storage tasks of a user and the information of the racks corresponding to the available storage nodes, determining a number of rounds required for accessing an available volume list, polling the racks corresponding to all the available storage nodes in sequence, and selecting, from one currently polled rack, one available volume in one available storage node that is arranged in a front in the currently polled rack at each round until the current storage tasks of the user are completed; and
returning the determined to-be-accessed storage nodes to a client for use by the user.

2. The iSCSI service load balancing method according to claim 1, wherein uniformly distributing the volumes onto the different target objects comprises:
creating the plurality of target objects and a plurality of threads on an iSCSI service corresponding to each available storage node, wherein each thread independently corresponds to the available volumes on the target objects; and
performing a remainder calculation operation on target-object identifiers through volume identifiers to make that the volumes are uniformly distributed onto the different target objects.

3. The iSCSI service load balancing method according to claim 2, wherein the volume identifiers of the plurality of volumes are numbered from 1 to n; the target-object identifiers of the plurality of target objects are numbered from 1 to n; and performing the remainder calculation operation on the target-object identifiers through the volume identifiers to make that the volumes are uniformly distributed onto the different target objects comprises:
performing the remainder calculation operation on the volume identifier of each volume and a maximum value of the target-object identifiers to make that the volumes are uniformly distributed onto the different target objects.

4. The iSCSI service load balancing method according to claim 1, wherein uniformly distributing the volumes onto the different target objects comprises:
creating the plurality of target objects and a plurality of threads on an iSCSI service corresponding to each available storage node, wherein each thread independently corresponds to the available volumes on the target objects; and
performing a remainder calculation operation on a quantity of the target objects through volume identifiers to make that the volumes are uniformly distributed onto different target objects.

5. The iSCSI service load balancing method according to claim 2, wherein a quantity of the target objects is correspondingly the same as a quantity of the threads, and the threads are bound to the target objects in a one-to-one corresponding manner.

6. The iSCSI service load balancing method according to claim 1, wherein arranging the available storage nodes according to the information of the available volumes in the available storage nodes is:
performing an ascending arrangement on the available storage nodes according to quantity information of the available volumes in the available storage nodes.

7. The iSCSI service load balancing method according to claim 1, wherein according to the quantity of the available storage nodes required by the current storage tasks of the user and the information of the racks corresponding to the available storage nodes, determining the number of rounds required for accessing the available volume list is:
performing a division operation on the quantity of the available storage nodes required by the current storage tasks of the user and quantity information of the racks corresponding to the available storage nodes; in response to that there is a remainder, indicating that the number of rounds required for accessing the available volume list is a quotient of the quantity of the available storage nodes required by the current storage tasks of the user and the quantity information of the racks corresponding to the available storage nodes plus 1; and in response to that there is no remainder, indicating that the number of rounds required for accessing the available volume list is a quotient of the quantity of the available storage nodes required by the current storage tasks of the user and the quantity information of the racks corresponding to the available storage nodes.

8. The iSCSI service load balancing method according to claim 1, wherein acquiring the information of the racks where the available storage nodes are located and the information of the available volumes in the available storage nodes comprises:
acquiring the information of the racks where the available storage nodes are located and quantity information of the available volumes in the available storage nodes from a monitoring service process.

9. The iSCSI service load balancing method according to claim 1, wherein the method further comprises:
selecting the available volumes in a same available storage node according to an order of a quantity of the available volumes contained in the target objects.

10. The iSCSI service load balancing method according to claim 9, wherein selecting the available volumes according to the order of the quantity of the available volumes contained in the target objects comprises:
performing an ascending arrangement on the available target objects according to quantity information of the available volumes in the available target objects in each available storage node.

11. The iSCSI service load balancing method according to claim 1, wherein the method further comprises:
establishing a polling linked list for each rack, wherein the polling linked list generates a hash table by taking the acquired information of the rack as a subscript, and records a number of times of polling of the corresponding rack.

12. The iSCSI service load balancing method according to claim 11, wherein the numbers of times of polling of all the racks are the same, and are equal to the number of rounds required by the current storage tasks for accessing the available volume list.

13. The iSCSI service load balancing method according to claim 11, wherein the number of times of polling of at least one rack is the same as the number of rounds required by the current storage tasks for accessing the available volume list.

14. The iSCSI service load balancing method according to claim 13, wherein the number of times of polling of the rack, which is the same as the number of rounds required by the current storage tasks for accessing the available volume list, is a minimum value of the numbers of times of polling of all the racks corresponding to the available storage nodes.

15. The iSCSI service load balancing method according to claim 1, wherein returning the determined to-be-accessed storage nodes to the client for use by the user is: arranging the determined to-be-accessed storage nodes according to the information of the available volumes in the available storage nodes, generating storage node linked lists, and returning the generated storage node linked lists to the client for use by the user in a unified way.

16. The iSCSI service load balancing method according to claim 15, wherein arranging the determined to-be-accessed storage nodes according to the information of the available volumes in the available storage nodes and generating the storage node linked lists comprises:
arranging the determined to-be-accessed storage nodes according to the information of the available volumes in the available storage nodes and generating unidirectional storage node linked lists.

17. The iSCSI service load balancing method according to claim 15, wherein arranging the determined to-be-accessed storage nodes according to the information of the available volumes in the available storage nodes and generating the storage node linked lists comprises:
arranging the determined to-be-accessed storage nodes according to the information of the available volumes in the available storage nodes and generating bidirectional storage node linked lists.

18. (canceled)

19. An electronic device, comprising: a memory configured to store a computer program; and a processor configured to implement, when executing the computer program, the steps of the iSCSI service load balancing method according to claim 1.

20. A non-transitory computer-readable storage medium, wherein the non-transitory computer-readable storage medium stores a computer program, and the non-transitory computer program, when executed by a processor, implement the steps of the iSCSI service load balancing method according to claim 1.

21. The iSCSI service load balancing method according to claim 1, wherein the available storage nodes refers to storage nodes in a working state.
